(19) United States
(12) Patent Application Publication
(10) Pub. No.: US 2007/0269692 A1
(43) Pub. Date: Nov. 22, 2007

(54) Fuel Cell Apparatus and a Charging/Discharging Management System and Method Using Such Apparatus

(75) Inventors: Charn-Ying Chen, Taoyuan City (TW); Chi-Yuan Chang, Taichung City (TW); Chun-Lung Chang, Hsinchu County (TW); Yeong-Der Lin, Taoyuan County (TW); Der-Hsing Liou, Taipei County (TW)

Correspondence Address: WPAT, PC;INTELLECTUAL PROPERTY ATTORNEYS, 2030 MAIN STREET, SUITE 1300, IRVINE, CA, 92614, US

(73) Assignee: INSTITUTE OF NUCLEAR ENERGY RESEARCH ATOMIC ENERGY, Taoyuan County (TW)

(21) Appl. No.: 11/465,755

(22) Filed: Aug. 18, 2006

(30) Foreign Application Priority Data
May 19, 2006 (TW) 095117754

(51) Int. Cl. H01M 8/04; H01M 10/46

(52) U.S. Cl. 429/23; 429/9; 320/101

(57) ABSTRACT

The present invention relates to a fuel cell apparatus, which comprises: a fuel cell, for providing a first voltage to an electrical load; and an auxiliary power device, electrically connected to the fuel cell and the load, for providing a second voltage to the electrical load while enabling the second voltage to be smaller than the first voltage. By the aforesaid fuel cell apparatus, the present invention further discloses a charging/discharging management system and method for efficiently managing and distributing the power generated from the fuel cell apparatus by the use of a plurality of auxiliary power modules and a switch control unit so as to provide a stable and efficient power supply to the electrical load.

### FIELD OF THE INVENTION

The present invention relates to a fuel cell apparatus, and more particularly, to a system and method for managing the operation and the charging/discharging of such fuel cell apparatus that is capable of enabling the fuel cell apparatus to provide a steady electrical output power to an electrical load by connecting fuel cells of the fuel cell apparatus to an auxiliary power device and enabling the auxiliary power device to generate sufficient power and supply the same to the load while the power output of the fuel cells is short to fulfill the power requirement of the electrical load.

### BACKGROUND OF THE INVENTION

A fuel cell is an electrochemical energy conversion device, similar to a battery in that it provides continuous DC power, which converts the chemical energy from a fuel directly into electricity and heat. For example, one type of fuel cell includes a proton exchange membrane (PEM), often called a polymer electrolyte membrane, that permits only protons to pass between an anode and a cathode of the fuel cell. At the anode, diatomic hydrogen a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. When operated directly on hydrogen, the fuel cell produces this energy with clean water as the only by-product. Unlike a battery, which is limited to the stored energy within, a fuel cell is capable of generating power as long as fuel is supplied from an external fuel container. Although hydrogen is the primary fuel source for fuel cells, the process of fuel reforming allows for the extraction of hydrogen from more widely available fuels such as natural gas and propane or any other hydrogen containing fuel. For a growing number of power generators and users, fuel cells are the key to the future since it is an environment-friendly energy source with high energy conversion efficiency.

As the electricity generation and supplying of fuel cells can be greatly affected by the concentration of fuel used thereby, the reaction temperature, the fuel supply and the movement of electrons traveling therein, a conventional fuel cell stack may have a relatively slow transient response that causes any increase in its fuel supply to significantly lag the increased demand for power. As a result, when the power that is demanded by an electrical load increases, the cell voltages of the fuel cell stack may significantly decrease due to the lack of a sufficient fuel flow until the rate of the fuel supply increases to the appropriate level. Due to the delayed response of the fuel supply, it is difficult for the fuel cell stack to increase its power supply to the electrical load instantly, that is, the fuel cell is temporarily unable to meet the transient power demand. Yet another problem arising from such a scenario is that a transient power output instability may happen each time when fuel is supplied to the fuel cell stack since each supplying of fuel may cause the fuel concentration to change.

In order to avoid the aforesaid problems of transient power demand and transient power output instability, most prior-art fuel cell apparatus may have a capacitor or a secondary battery set to be integrated into the circuitry thereof. For example, a fuel cell apparatus, disclosed in TW. Pat. No. 92133136, is characterized in that it is capable of reducing power loss during a process of energy conversion as it enables the voltage of a fuel cell stack thereof to be smaller than/equal to that of a secondary battery set thereof while the fuel cell stack is required to output at its maximum. However, although the secondary battery set of the aforesaid fuel cell apparatus is good for power loss reduction, it still can not prevent a transient response instability or a lagging response from causing output voltage of the fuel cell apparatus to drop, owing to that the fuel cell stack in the fuel cell apparatus is constantly operating in a high-current, low-voltage status and thus is easy to deteriorate. In addition, as the output voltage of the fuel cell apparatus is dropped, there is no appropriate threshold voltage means arranged in the aforesaid fuel cell apparatus for activating the recovery of the fuel cell stack.

Therefore, it is in need of a system and method for managing the operation and the charging/discharging of an improved fuel cell apparatus that is free from the aforesaid shortcomings.

### SUMMARY OF THE INVENTION

It is the primary object of the present invention to provide a system and method for managing the operation and the charging/discharging of an improved fuel cell apparatus that is capable of enabling the fuel cell apparatus to provide a steady electrical output power to an electrical load by the cooperation of a fuel cell attack and a secondary battery set, whereas the operating voltage of the secondary battery set is enabled to be smaller than/equal to the output voltage of the fuel cell stack when the fuel cell apparatus is specified to output a specific power by the electrical load.

It is the another object of the present invention to provide a system and method for managing the operation and the charging/discharging of an improved fuel cell apparatus that is capable of preventing the transient response instability of a fuel cell stack from causing the voltage thereof to drop suddenly by the affection of an electrical load, and thus enabling the fuel cell stack to recover from the transient response instability while prolonging the lifespan of the fuel cell stack, whereas the operating voltage of the secondary battery set is enabled to be smaller than/equal to the output voltage of the fuel cell stack when the fuel cell apparatus is specified to output a specific power by the electrical load.

Yet, another object of the present invention is to provide a system and method for managing the operation and the charging/discharging of an improved fuel cell apparatus that is capable of enabling the fuel cell apparatus to provide a steady electrical output power to an electrical load, not only by the cooperation of a fuel cell attack and a secondary battery set, but also by serial-connecting while managing the charging/discharging of those distributed power sources of the fuel cell apparatus.

To achieve the above objects, the present invention provides a fuel cell apparatus, which comprises: a fuel cell, for providing a first voltage to an electrical load; and an auxiliary power device, electrically connected to the fuel cell and the load, for providing a second voltage to the electrical load while enabling the second voltage to be smaller than/equal to the first voltage.

Preferably, the auxiliary power device can be a rechargeable battery selected from the group consisting of a Lithium-ion batter, Nickel-Metal hydride battery Nickel-Cadmium battery, Lead-Calcium battery and the combination thereof.

Preferably, the auxiliary power device can be a set of rechargeable batteries, each selected from the group consisting of a Lithium-ion batter, Nickel-Metal hydride battery Nickel-Cadmium battery, and Lead-Calcium battery.

Preferably, the fuel cell is connected to a charger, being connected to the auxiliary power device by a control unit, wherein the control unit is capable of detecting the power of the rechargeable batteries of the auxiliary power device and thus basing on the detection to select the rechargeable batteries of insufficient power for charging by the charger. In a preferred aspect, the charger can be a voltage charger or a current charger. Moreover, the fuel cell apparatus further comprises a switch control unit, electrically connected to the electrical load, used for selecting the rechargeable batteries of sufficient power out of the rechargeable batteries of the auxiliary power device while enabling the selected rechargeable batteries to provide power to the electrical load.

Preferably, the first voltage is the voltage value corresponding to the maximum value of a polarization curve of the fuel cell subjecting to the electrical load, but is not limited thereby.

Moreover, to achieve the above object, the present invention provides a fuel cell system, which comprises:
a fuel cell stack, for providing a first voltage to an electrical load while supplying power to a plurality of chargers;
a plurality of auxiliary power devices, each further comprising:
   a plurality of parallel-connected power management units, each connecting to one corresponding charger selected from the plural chargers, being used for providing a second voltage to the electrical load while enabling the second voltage to be smaller than/equal to the first voltage; and
   a plurality of rechargeable batteries;
a control unit; electrically connected to the plural charger and the plural auxiliary power devices and the plural chargers, being used for detecting the power of the plural rechargeable batteries of the auxiliary power device and thus basing on the detection to select the rechargeable batteries of insufficient power from each auxiliary power device for charging by chargers corresponding thereto; and
a plurality of switch control units, each electrically connected to one corresponding auxiliary power device selected from the plural auxiliary power devices, used for selecting the rechargeable batteries of sufficient power while enabling the selected rechargeable batteries to provide power to the electrical load.

In addition, to achieve the above object, the present invention provides a method for managing the operation and the charging/discharging of a fuel cell apparatus, which comprises steps of: (a) providing a fuel cell stack, at least an auxiliary power device, a control unit and a plurality of switch control unit; (b) performing a power detection procedure for determining whether the fuel cell stack or the at least one auxiliary power device should be selected for providing power to an electrical load; (c) comparing the power generated by the fuel cell stack with a first threshold value for determining whether the at least one auxiliary power device should be charger as the fuel cell stack is selected for providing power to the electrical load.

Preferably, the first threshold value is defined to be the voltage of the electrical load while charging the fuel cell stack.

Preferably, each auxiliary power device further comprises: a plurality of power management units, each connecting to one corresponding switch control unit selected from the plural switch control units, each further comprising a plurality of rechargeable batteries. In a preferred aspect, the power detection procedure of the step (b) further comprises steps of: (b11) selecting the auxiliary power device for providing power to the electrical load while the voltage of the fuel cell stack is small than that of the auxiliary power device; (b12) determining the power statuses of the rechargeable batteries in each power management unit; (b13) selecting those rechargeable batteries of sufficient voltage by the switch control units corresponding thereto while serially connecting those selected rechargeable batteries for providing power to the electrical load; and (b14) performing the step (b) in a repetitive manner.

Moreover, in a preferred aspect, the power detection procedure of the step (b) further comprises steps of: (b21) enabling the fuel cell stack to connect to the electrical load electrically while the voltage of the fuel cell stack is larger than that of the auxiliary power device; (b22) detecting and determining whether the voltage of the fuel cell stack is smaller than a second threshold value while the fuel cell stack is connecting to the electrical load; if so, enabling the auxiliary power device to connect to the electrical load electrically so as to enable the auxiliary power device to provide power to the electrical load; and (b23) performing the step (b) in a repetitive manner. It is noted that the second threshold value can be a voltage specified and required by the electrical load.

Preferably, the step (c) further comprises steps of: (c1) performing a charging operation while the voltage of the fuel cell stack is larger than the first threshold value. In addition, the step (c1) further comprises steps of: (c11) stopping he charging operation while the voltage of the fuel cell stack is small than/equal to the first threshold value; and (c12) performing the step (b) in a repetitive manner. In a preferred aspect, the auxiliary power device further comprises a plurality of power management units, each having a plurality of rechargeable batteries; wherein each power management unit is connected to a charger. Therefore, by the plural power management units, the charging operation of step (c) further comprises steps of: (c11′) making an evaluation to determine the power status of the rechargeable batteries of each power management unit; and (c12′) selecting the rechargeable batteries of low voltage out of the aforesaid rechargeable batteries while connecting the same to its corresponding chargers for charging.

Preferably, the step (c) further comprises steps of: (c2) stopping the charging operation while the voltage of the fuel cell stack is small than the first threshold value; and (c3) performing the step (b) in a repetitive manner.

Preferably, the voltage of the auxiliary power device is designed to be small than/equal to that of the fuel cell stack.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a fuel cell apparatus according to a preferred embodiment of the invention.

FIG. 2 is a schematic view of a fuel cell system according to a preferred embodiment of the invention.

FIG. 3 is a schematic diagram depicting the fuel cell system operating in its power supplying mode according to the present invention.

FIG. 4 is a schematic diagram depicting the fuel cell system operating in its power charging mode according to the present invention.

FIG. 5 is a schematic diagram depicting the fuel cell system operating in its power compensating mode according to the present invention.

FIG. 6 shows a polarization curve of a fuel cell according to the present invention.

FIG. 7 is a schematic view of a fuel cell system according to another preferred embodiment of the invention.

FIG. 8A is a flow chart showing steps of a method for managing the operation and the charging/discharging of a fuel cell apparatus according to a preferred embodiment of the invention.

FIG. 8B is a flow chart showing steps of enabling the auxiliary power device to be used as a power supply according to a preferred embodiment of the invention.

FIG. 8C is a flow chart showing steps of enabling the fuel cell stack to be used as a power supply according to a preferred embodiment of the invention.

FIG. 8D˜FIG. 8E shows steps of enabling the fuel cell stack to charge the auxiliary power device according to a preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

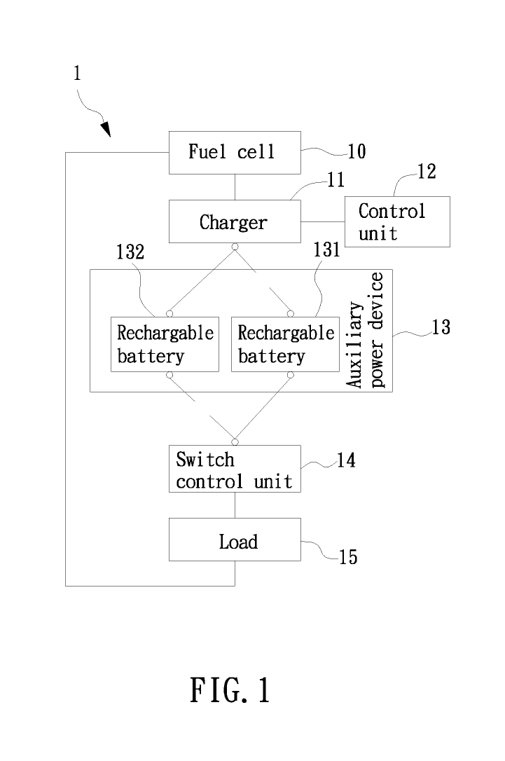

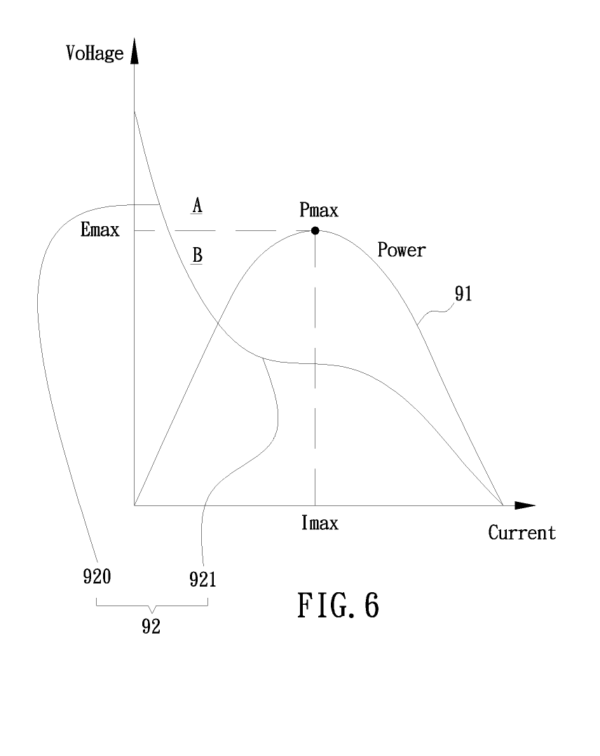

Please refer to FIG. 1, which is a schematic view of a fuel cell apparatus according to a preferred embodiment of the invention. As seen in FIG. 1, a fuel cell apparatus 1 is comprised of a fuel cell 10 and an auxiliary power device 13; wherein the fuel cell 10 is used for providing a first voltage to an electrical load 15. It is noted that the fuel cell 10 can be a direct methanol fuel cell or an ethanol fuel cell, but is not limited thereby. As the power curve 91 and the polarization curve 92 shown in FIG. 6, he first voltage is the voltage value corresponding to the maximum value of a polarization curve of the fuel cell 10 subjecting to the electrical load 15, but is not limited thereby.

In order to prevent transient response instability of the fuel cell from causing the power output thereof to become unstable, or when the fuel cell is required to meet the transient power demand caused by the varying load, i.e. to increase its power supply to the electrical load instantly, the fuel cell 10 is connected to the auxiliary power device 13, that is also connected to the electrical load 15 for providing a second voltage to the electrical load 15, whereas the fuel cell apparatus 1 is characterized in that the second voltage is defined to be smaller than/equal to the first voltage. In a preferred aspect, the auxiliary power device 13 includes at least two rechargeable batteries 131, 132, wherein any of the least two rechargeable batteries 131, 132 can be a rechargeable battery selected from the group consisting of a Lithium-ion batter, Nickel-Metal hydride battery Nickel-Cadmium battery, Lead-Calcium battery and the combination thereof.

While the fuel cell 10 is subjected to a transient response instability that cause its voltage to drop or become unstable, the voltage thereof can keep dropping if there is no auxiliary power device 13 existed in the circuitry thereof. As seen in FIG. 6, the polarization curve 92 can be generally divided into a curve traveling in the A area and that traveling in the B area, i.e. the A-area curve 920 and the B-area curve 921. The A-area curve 920 represents the voltage-current relationship of the fuel cell 10 as it is in open circuit, and the B-area curve 921 represents the voltage-current relationship of the fuel cell 10 as it is connected to the electrical load 15. It is known that when a large current is provided to the electrical load 15 by the fuel cell 10, the voltage of the fuel cell will drop conceivably, and the electrical load 15 subjected to the large current is usually suffer the problem of heat loss that cause electrical load 15 to be not able to use the energy provided by the fuel cell 100 efficiently. Hence, the auxiliary power device 13 is provided and connected to the fuel cell 100 so as to enabling the fuel cell 10 to recover from the transient response instability while prolonging the lifespan of the fuel cell 10. In addition, by the assistant provided by the auxiliary power device 13, the power provided to the electrical load 15 from the fuel cell apparatus 1 will not be affected by the voltage dropping of the fuel cell 10 since the auxiliary power device 13 will be activated as soon as the dropping of the voltage of the fuel cell 10 enabling the voltage of the fuel cell 10 to be equal to that of the auxiliary power device 13. Moreover, also by the assistant of the auxiliary power device 13, the voltage dropping of the fuel cell 10 will not seriously drop the output voltage of the fuel cell apparatus 1 and cause low energy usage efficiency.

As seen in FIG. 1, in order to increase the recovery ability of the fuel cell apparatus 1, the fuel cell 10 is further connected to a charger 11 and two rechargeable batteries 131, 132 is installed in the auxiliary power device 13. The charger 11 is connected to a control unit 12 and the auxiliary power device 13, whereas the control unit 12 is capable of detecting the power of the two rechargeable batteries 131, 132 and thus basing on the detection to select any rechargeable battery of insufficient power for charging by the charger 11. In a preferred aspect, the charger 11 can be a voltage charger or a current charger. Moreover, the fuel cell apparatus 1 further comprises a switch control unit 14, which is electrically connected to the electrical load 15 and the auxiliary power device 13, and is used for selecting the rechargeable batteries of sufficient power out of the two rechargeable batteries 131, 132 while enabling the selected rechargeable batteries to provide power to the electrical load 15.

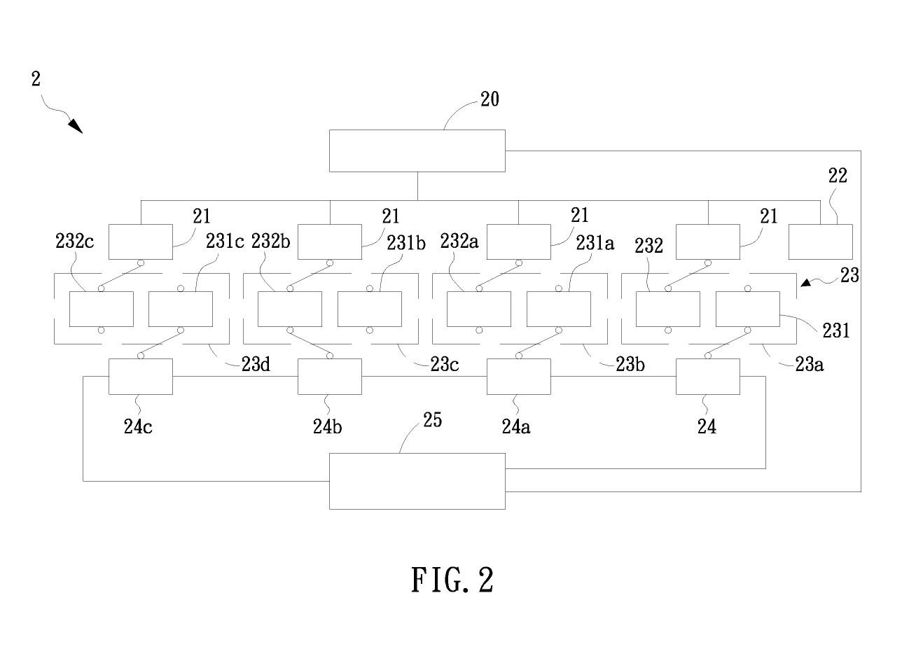

From the above description, an intelligent fuel cell apparatus can be established, by which not only a steady power supply can be secured, but also the lifespan of the fuel cell of the fuel cell apparatus can be prolonged. Please refer to FIG. 2, which is a schematic view of a fuel cell system according to a preferred embodiment of the invention. In FIG. 2, the fuel cell system 2 is comprised of: a fuel cell stack 20, for providing a first voltage to an electrical load 25 while supplying power to a plurality of chargers 21; an auxiliary power device 23; a control unit 22; and a plurality of switch control units, represented by the four switch control units 24, 24a, 24b, 24c shown in FIG. 2.

Wherein, the fuel cell stack 20 can be a plurality of serial-connected fuel cell. The auxiliary power device 23 further comprises a plurality of parallel-connected power management units 23, represented by the four power management units 23a, 23b, 23c, 23d, shown in FIG. 2, each connecting to one corresponding charger 21 selected from the plural chargers 21, being used for providing a second voltage to an electrical load 25 while enabling the second voltage to be smaller than/equal to the first voltage. In addition, the auxiliary power device 23 further comprises a plurality of rechargeable batteries. In the embodiment shown in FIG. 2, there is only one auxiliary power device 23 that is composed of four power management units 23a, 23b, 23c, 23d, each having two rechargeable batteries 231, 232, is installed in the fuel cell system 2. However, there can be more than one auxiliary power device 23 in the fuel cell apparatus 2 and used as the recovery power of the electrical load 25, whereas the number of the power management unit, as well as that of the rechargeable batteries, is not limited thereby.

The control unit 22 is electrically connected to the plural chargers 21 and the plural power management units 23a˜23d, which is used for detecting the power of the rechargeable batteries 234, 232 of each power management unit and thus basing on the detection to select the rechargeable batteries of insufficient power for charging by the charger corresponding thereto. In addition, the plural switch control units, represented by the four 24, 24a, 24b, 24c shown in FIG. 2, are respectively connected to the plural power management units 23a˜23d, which is used for selecting while parallel-connecting the rechargeable batteries of sufficient power out of the rechargeable batteries of those plural power management units 23a˜23d so as to enable the selected rechargeable batteries to provide power to the electrical load 25. As seen in FIG. 2, by the intelligent charging/discharging management enabled by the cooperation of the control unit 22 and the plural switch control units 24, 24a, 24b, 24c, the independent power sources, i.e. the plural power management units 24, 24a, 24b, 24c, can be integrated for providing power to the electrical load 25.

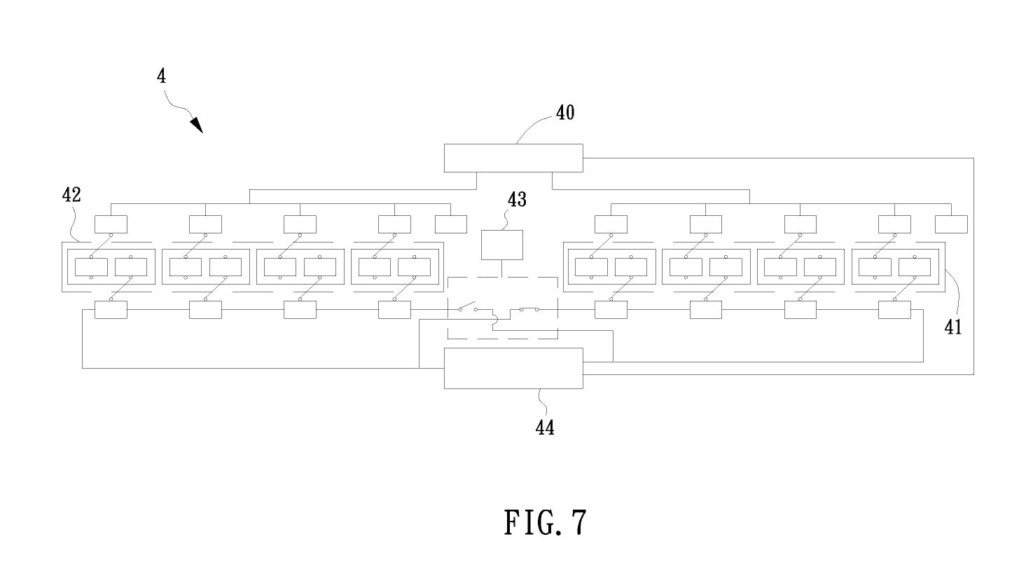

Please refer to FIG. 7, which is a schematic view of a fuel cell system according to another preferred embodiment of the invention. As seen in FIG. 7, a fuel cell stack 40 is used for supplying power to an electrical load 44 and charging the two auxiliary power devices 41, 42. The two auxiliary power devices 41, 42 are acting as the backup for each other that can be selected and controlled to supply power to the electrical load 44 by the determination of a switch control 43. That is, as the power status of one operating auxiliary power device, said the auxiliary power device 41, is problematic, the switch control 43 will stop supplying power to the electrical load from the auxiliary power device 41 and activate the auxiliary power device 42 to operate for supplying power to the electrical load 44, and thus the power supply of the electrical load 44 can be secured without breakage. Although there are only two auxiliary power devices 41, 42 shown in the embodiment of FIG. 7, the number of that is not limited thereby.

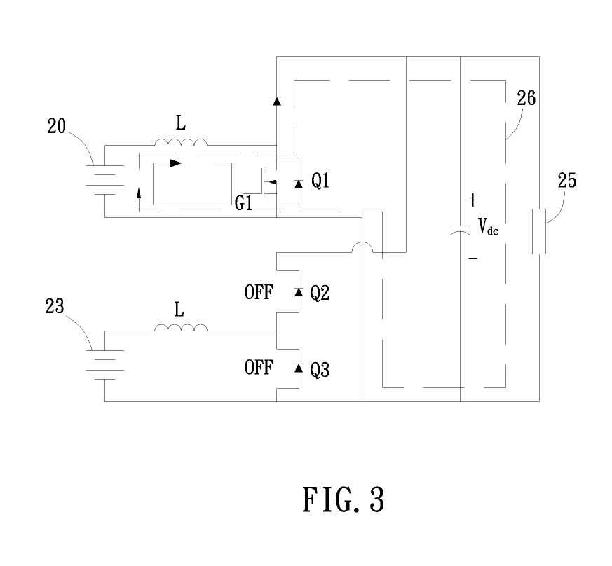

The operating mode of the fuel cell apparatus/system of the invention can be categorized into three modes: power supplying mode, power charging mode and power compensating mode. Please refer to FIG. 3, which is a schematic diagram depicting the fuel cell system operating in its power supplying mode according to the present invention. As the fuel cell system is operating in its power supplying mode, the fuel cell stack 20 is used for providing power to an electrical load 25 directly. In the embodiment of FIG. 3, the output voltage of the fuel cell stack 20 is stabilized by the use of a boost converter 26 in a closed circuit control manner. It is noted that the circuit design of the boost converter 26 is known to those skilled in the art, and this is not described further herein.

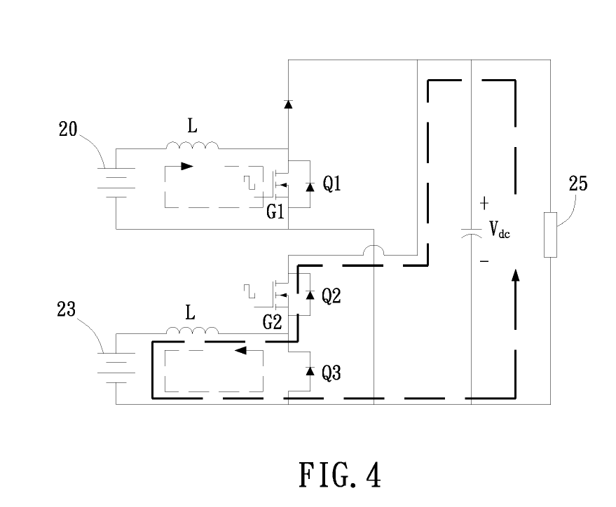

Please refer to FIG. 4, is a schematic diagram depicting the fuel cell system operating in its power charging mode according to the present invention. As the fuel cell system is operating in its power charging mode, a two-step constant-current/constant-voltage (CC-CV) charging technique is adopted for charging the rechargeable batteries of the auxiliary power device, that is, a constant current is provided to the rechargeable batteries of the auxiliary power device until the voltage across the rechargeable batteries reaches a floating charging voltage of the same, and when this value is reached, the current delivered to the rechargeable batteries must be varied to maintain a constant load voltage, by which the charging time of the rechargeable batteries can be shorten and thus the lifespan of the same is prolonged. In FIG. 4, the charging of the auxiliary power device 23 is enabled by the control of the transistor G2. When the fuel cell system is enabled to operate in power charging mode, it is concluded that there must be certain recovery power being fed back from the inductive load, and thus the feedback power can be fed to the rechargeable batteries for activating the power charging mode. Moreover, the activation of the power charging mode is dependent on the determination basing on a system power prediction means, which is summed up by the function (1) listed as following:

W=K_{P}(W_{K}−W*) (1)

whereas W_{K} represents the total power of the system
W* represents the power consumed by the load
K_{P} represents a constant of proportionality

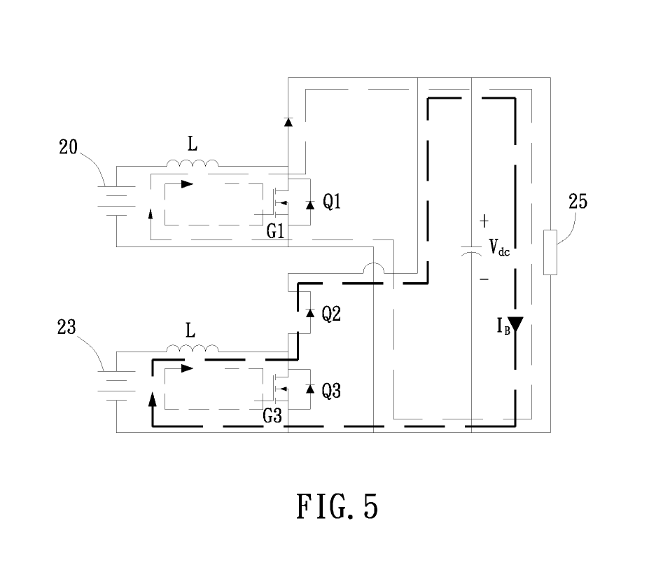

Please refer to FIG. 5, which is a schematic diagram depicting the fuel cell system operating in its power compensating mode according to the present invention. When the fuel cell system is enabled to operate in power compensating mode, it is concluded that the power provided to the load from the fuel cell stack 20 is insufficient, or the fuel cell stack 20 is in transient response instability, that cause the output voltage to drop. The activation of the power compensating mode is dependent on the detection of the variation of the output voltage V_{dc} while the capacity of compensating current I_{B} is determined by the function (2) listed as following:

I_{B}=K_{P}ΔV_{dc}+K_{I}∫ΔV_{dc} dt (2)

whereas K_{P} represents a constant of proportionality
K_{I} represents a constant of integration
   That is, by the use of a constant-current hysteretic control means for comparing the current generated from the fuel cell stack with the power required by the load, the capacity of the compensating current I_{B} can be determined while maintaining the stable of the output voltage V_{dc} by the control of the transistor G3 and the two diodes Q2, Q3, so that the auxiliary power device 23 is enabled to provide power to the load 25 when the fuel cell stack 20 is unstable.

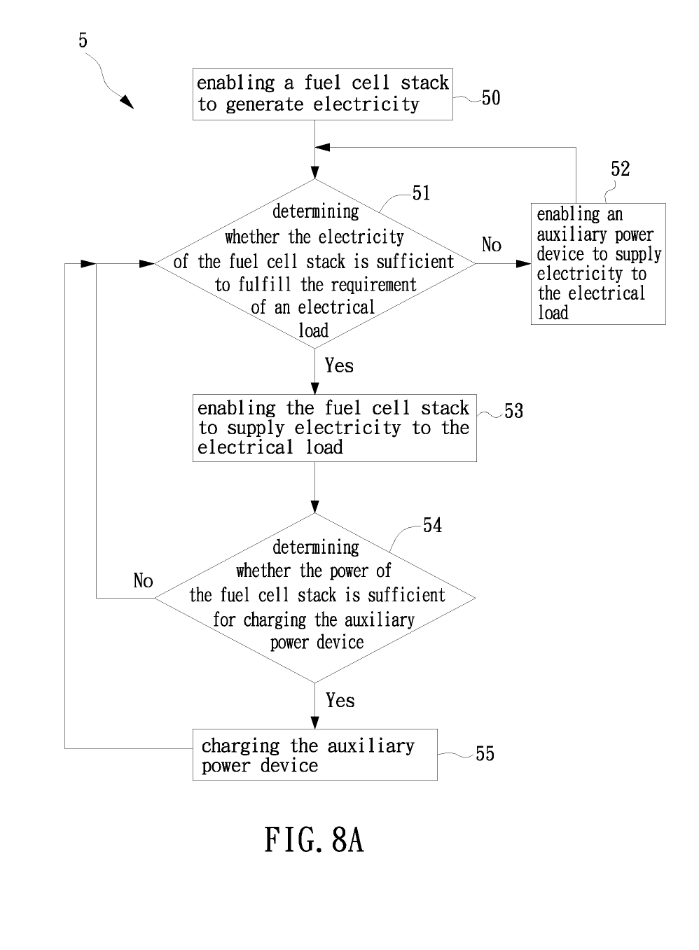

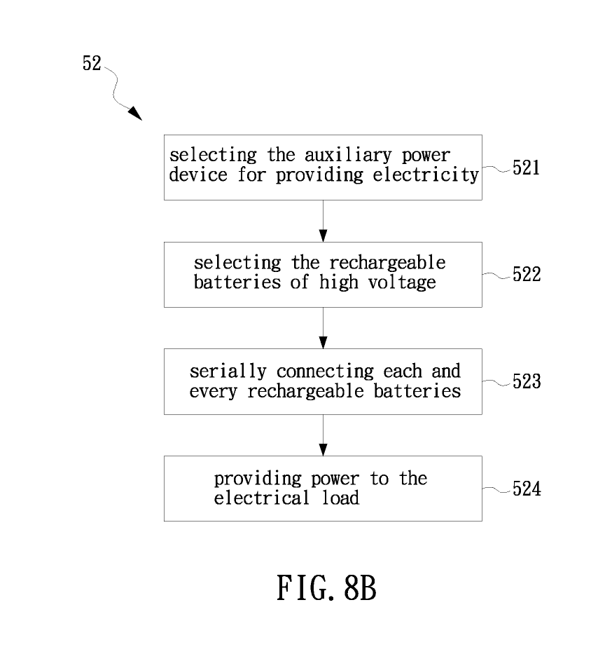

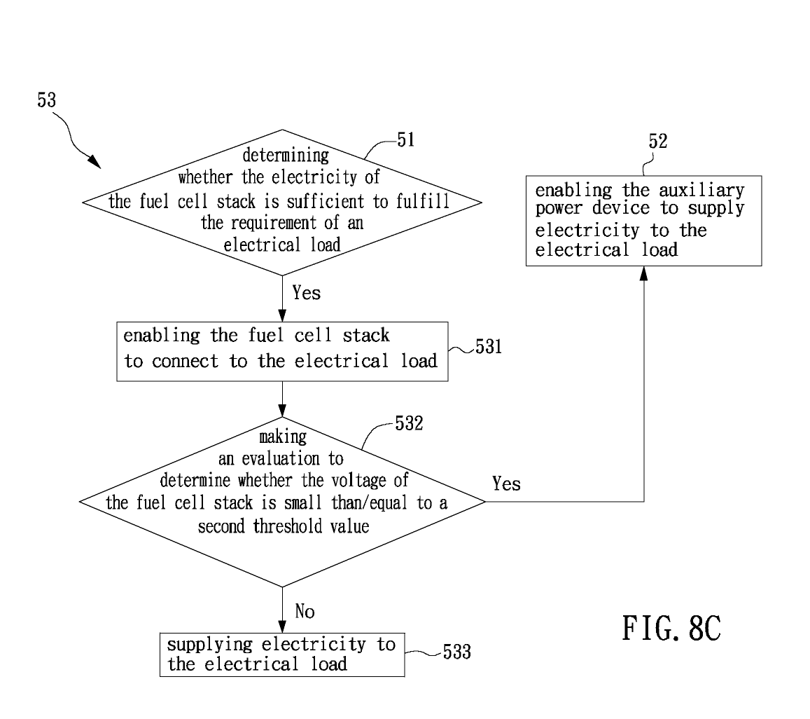

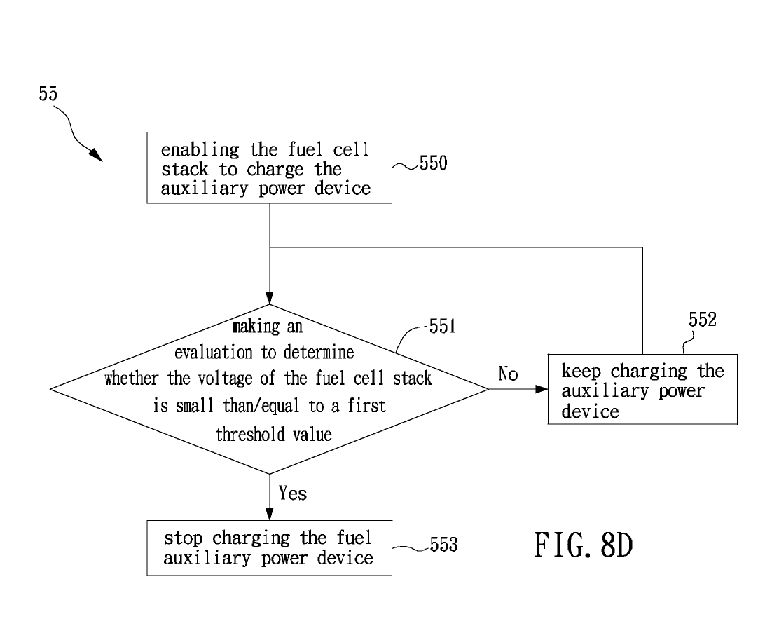

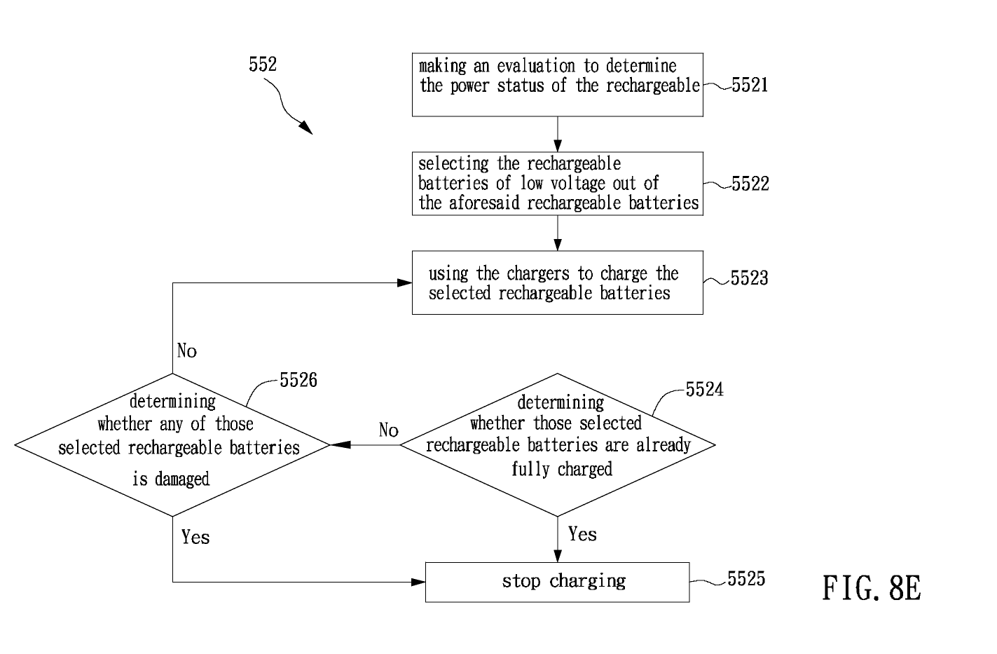

Please refer to FIG. 8A, is a flow chart showing steps of a method for managing the operation and the charging/discharging of a fuel cell apparatus according to a preferred embodiment of the invention. The method of FIG. 8A is implemented in the fuel cell system 2 as that shown in FIG. 2, and starts at step 50. At step 50, a fuel cell stack 20 is enabled to generate electricity, and then the flow proceeds to step 51. At step 51, an evaluation is made for determining whether the electricity of the fuel cell stack 20 is sufficient to fulfill the requirement of an electrical load 25; if not the flow proceeds to step 52, otherwise, the flow proceeds to step 53. At step 52,the auxiliary power device 23 to supply electricity to the electrical load 25. At step 53, the fuel cell stack 20 is enabled to supply electricity to the electrical load 25, and then the flow proceeds to step 54. At step 54, an evaluation is made for determining whether the power of the fuel cell stack is sufficient for charging the auxiliary power device 23; if so, the flow proceeds to step 55, otherwise, the flow goes back to step 51. At step 55, the auxiliary power device 23 is charged.

Moreover, when the auxiliary power device 23 is enabled to supply electricity to the electrical load 25 as referred in the step 52 of FIG. 8A, the steps of enabling the auxiliary power device 23 to be used as a power supply of the electrical load 25 is illustrated in the flow chart of FIG. 8B. The flow chart of FIG. 8B starts at step 521. At step 521, where the auxiliary power device 23 is selected for providing electricity to the electrical load 25, and then the flow proceeds to step 522. At step 522, the switch control units 24, 24a, 24b, 24c are used for selecting while parallel-connecting the rechargeable batteries of sufficient power out of the rechargeable batteries 231, 232, 231a, 232a, 231b, 232b, 231c, 232c, of the power management units 23a, 23b, 23c, 23d while enabling the selected rechargeable batteries to provide power to the electrical load 25, and then the flow proceeds to step 524. At step 524, the power of those selected parallel-connecting rechargeable batteries is provided to the electrical load 25. It is noted that the voltage of those selected parallel-connecting rechargeable batteries is small than the operating voltage of the fuel cell stack 20, whereas the reasoning is described hereinbefore and thus is not described further herein.

In addition, when the power of the fuel cell stack 20 is sufficient to fulfill the requirement of an electrical load 25 and thus the fuel cell stack 20 is enabled to supply electricity to the electrical load 25 as referred in the step 53 of FIG. 8A, the steps of enabling fuel cell stack 20 to be used as a power supply of the electrical load 25 is illustrated in the flow chart of FIG. 8C. The flow chart of FIG. 8C starts at step 51, whereas the he power of the fuel cell stack 20 is determined to be sufficient for fulfilling the requirement of an electrical load 25, and then the flow proceeds to step 531. At step 531, the fuel cell stack 20 is connected to the electrical load 25, and then the flow proceeds to step 532. At step 532, an evaluation is made to determine whether the voltage of the fuel cell stack 20 is small than/equal to a second threshold value; is so, the flow proceeds to step 52 which is illustrated in FIG. 8A and FIG. 8B, otherwise, the flow proceeds to step 533. At step 533, the power of the fuel cell stack 20 is supplied to the electrical load 25. It is noted that the second threshold value is a voltage specified and required for enabling the electrical load 25 to operate normally.

As the evaluation performed in the step 54 of FIG. 8A determines that the power of the fuel cell stack 20 is sufficient to charge the auxiliary power device 23, and the step 55 of FIG. 8A for charging the auxiliary power device 23 is enabled, the steps of enabling the fuel cell stack to charge the auxiliary power device are illustrates in flow charts of FIG. 8D to FIG. 8E. The flow chart of FIG. 8D starts at step 550, where the fuel cell stack 20 is enabled to charge the auxiliary power device 23, and then the flow proceeds to step 551. At step 551, an evaluation is made to determine whether the voltage of the fuel cell stack is small than/equal to a first threshold value; is do, the flow proceeds to step 553, otherwise, the flow proceeds to step 552. At step 552, the fuel cell stack 20 is kept to charge the auxiliary power device 23. At step 553, the fuel cell stack 20 is stopped to charge the auxiliary power device 23. It is noted that he first threshold value is a voltage specified and required for enabling the electrical load 25 to operate normally.

As the fuel cell stack 20 is enabled to keep charging the auxiliary power device 23 as shown in the step 552 of FIG. 8D, steps for charging the rechargeable batteries of the auxiliary power device 23 are illustrates in the flow chart of FIG. 8E. The flow of FIG. 8E starts at step 5521. At step 5521, an evaluation is made to determine the power status of the rechargeable batteries 231, 232, 231a, 232a, 231b, 232b, 231c, 232c, of the power management units 23a, 23b, 23c, 23d, and then the flow proceeds to step 5522. At step 5522, the rechargeable batteries of low voltage are selected out of the aforesaid rechargeable batteries, and then the flow proceeds to step 5523. At step 5523, the chargers are enabled to charge the selected rechargeable batteries, and then the flow proceeds to step 5524. At step 5521, an evaluation is made for determining whether those selected rechargeable batteries are already fully charged; if so, the flow proceeds to step 5525, otherwise, the flow proceeds to step 5526. At step 5525, the charging is stopped. At step 5526, an evaluation is made for determining whether any of those selected rechargeable batteries is damaged.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A fuel cell apparatus, comprising:
a fuel cell, for providing a first voltage to an electrical load; and
an auxiliary power device, electrically connected to the fuel cell and the load, for providing a second voltage to the electrical load while enabling the second voltage to be smaller than/equal to the first voltage.

2. The fuel cell apparatus of claim 1, wherein the auxiliary power device further comprises at least a rechargeable battery.

3. The fuel cell apparatus of claim 2, wherein the fuel cell is connected to a charger, being connected to the auxiliary power device by a control unit, while the control unit is capable of detecting the power of the rechargeable batteries of the auxiliary power device and thus basing on the detection to select the rechargeable batteries of insufficient power for charging by the charger.

4. The fuel cell apparatus of claim 3, wherein the charger is a device selected from the group consisting of a voltage charger and a current charger.

5. The fuel cell apparatus of claim 3, wherein, the fuel cell apparatus further comprises:
a switch control unit, for selecting the rechargeable batteries of sufficient power out of the rechargeable batteries of the auxiliary power device while enabling the selected rechargeable batteries to provide power to the electrical load.

6. The fuel cell apparatus of claim 1, wherein the first voltage is the voltage value corresponding to the maximum value of a polarization curve of the fuel cell subjecting to the electrical load.

7. A fuel cell system, comprising:
a fuel cell stack, for providing a first voltage to an electrical load while supplying power to a plurality of chargers;
a plurality of auxiliary power devices, each further comprising:
a plurality of parallel-connected power management units, each connecting to one corresponding charger selected from the plural chargers, being used for providing a second voltage to the electrical load while enabling the second voltage to be smaller than/equal to the first voltage; and
a plurality of rechargeable batteries;
a control unit; electrically connected to the plural charger and the plural auxiliary power devices and the plural chargers, being used for detecting the power of the plural rechargeable batteries of the auxiliary power device and thus basing on the detection to select the rechargeable batteries of insufficient power from each auxiliary power device for charging by chargers corresponding thereto; and
a plurality of switch control units, each electrically connected to one corresponding auxiliary power device selected from the plural auxiliary power devices, used for selecting the rechargeable batteries of sufficient power while enabling the selected rechargeable batteries to provide power to the electrical load.

8. The fuel cell system of claim 7, wherein the first voltage is the voltage value corresponding to the maximum value of a polarization curve of the fuel cell subjecting to the electrical load.

9. The fuel cell system of claim 8, wherein each charger is a device selected from the group consisting of a voltage charger and a current charger.

10. A method for managing the operation and the charging/discharging of a fuel cell apparatus, capable of managing and stabilizing the power being supplied to an electrical load, comprising steps of:
(a) providing a fuel cell stack, at least an auxiliary power device, a control unit and a plurality of switch control unit;
(b) performing a power detection procedure for determining whether the fuel cell stack or the at least one auxiliary power device should be selected for providing power to the electrical load;
(c) comparing the power generated by the fuel cell stack with a first threshold value for determining whether the at least one auxiliary power device should be charger as the fuel cell stack is selected for providing power to the electrical load.

11. The method of claim 11, wherein each auxiliary power device further comprises:
a plurality of power management units, each connecting to one corresponding switch control unit selected from the plural switch control units, each further comprising a plurality of rechargeable batteries.

12. The method of claim 11, wherein the power detection procedure of the step (b) further comprises steps of:
(b11) selecting the auxiliary power device for providing power to the electrical load while the voltage of the fuel cell stack is small than that of the auxiliary power device;
(b12) determining the power statuses of the rechargeable batteries in each power management unit;
(b13) selecting those rechargeable batteries of sufficient voltage by the switch control units corresponding thereto while serially connecting those selected rechargeable batteries for providing power to the electrical load; and
(b14) performing the step (b) in a repetitive manner.

13. The method of claim 10, wherein the power detection procedure of the step (b) further comprises steps of:
(b21) enabling the fuel cell stack to connect to the electrical load electrically while the voltage of the fuel cell stack is larger than that of the auxiliary power device;
(b22) detecting and determining whether the voltage of the fuel cell stack is smaller than a second threshold value while the fuel cell stack is connecting to the electrical load; if so, enabling the auxiliary power device to connect to the electrical load electrically so as to enable the auxiliary power device to provide power to the electrical load; and
(b23) performing the step (b) in a repetitive manner.

14. The method of claim 13, wherein the second threshold value is a voltage specified and required by the electrical load.

15. The method of claim 10, wherein the step (c) further comprises steps of:
(c1) performing a charging operation while the voltage of the fuel cell stack is larger than the first threshold value; and
(c2) performing the step (b) in a repetitive manner.

16. The method of claim 15, wherein the step (c1) further comprises steps of:
(c11) stopping he charging operation while the voltage of the fuel cell stack is small than/equal to the first threshold value; and
(c12) performing the step (b) in a repetitive manner.

17. The method of claim 15, wherein each of the at least one auxiliary power device further comprises:
a plurality of power management units, each having a plurality of rechargeable batteries, while each power management unit being connected to a charger.

18. The method of claim 17, wherein the charging operation of step (c) further comprises steps of:
(c11′) making an evaluation to determine the power status of the rechargeable batteries of each power management unit; and
(c12′) selecting the rechargeable batteries of low voltage out of the aforesaid rechargeable batteries while connecting the same to its corresponding chargers for charging.

19. The method of claim 10, wherein the voltage of the at least one auxiliary power device is designed to be small than/equal to that of the fuel cell stack.

20. The method of claim 10, wherein the first threshold value is a voltage specified and required by the electrical load.
